(19) United States
(12) Patent Application Publication
(10) Pub. No.: US 2015/0053154 A1
(43) Pub. Date: Feb. 26, 2015

(54) Monoblock Engine

(71) Applicant: MAHINDRA AND MAHINDRA LIMITED, Mumbai (IN)

(72) Inventors: Abhaykumar Narayanrao Ganla, Pune (IN); Sachin Prabhakar Satdive, Aurangabad (IN); Dhatchnamoorthy Seshathri, Chennai (IN)

(21) Appl. No.: 14/389,386

(22) PCT Filed: Mar. 26, 2013
(86) PCT No.: PCT/IB2013/052377

§ 371 Date: Sep. 30, 2014

(30) Foreign Application Priority Data
Mar. 30, 2012 (IN) 993/MUM/2012

(51) Int. Cl. F02F 1/00; B22D 25/02; F02F 1/04; F02F 1/10; F02F 1/06

(52) U.S. Cl. CPC F02F 1/002; F02F 1/102; F02F 1/06; F02F 1/004; F02F 1/045; B22D 25/02
USPC 123/41.69; 123/193.3; 123/41.72; 123/668; 164/47

(57) ABSTRACT

The present invention discloses a monoblock engine in which the head and the block of the engine are cast integrally. The engine incorporates a cylinder and water coolant jackets, intake manifold and an exhaust manifold, vertical intake and exhaust valves, core removal holes, and a push-fit type cylinder liner which is secured in place so that leakage of fuel from the cylinder is eliminated. The water coolant jackets for the head and the block are connected using four water jacket gateways or connectors. The monoblock is fitted with the crankcase using a leak proof & robust flange-joint and mechanical fastening system which is easy to install. The invention is embodied for a single cylinder engine as well as multi-cylinder engines. By integrating cylinder head and manifolds with block, the critical joint between head and block and head and intake Manifold will be eliminated. At the same time, gasket and mechanical fasteners for tightening also can be eliminated. The water jacket design is communized & optimized for both head and block for better performance.

### FIELD OF INVENTION

The invention relates to an engine for automotive vehicles. In particular the invention relates to engines in which the cylinder head and block are cast integrally and which has leak proof joints and which is easy to cast and attach to the crankcase.

### BACKGROUND OF INVENTION

Monoblock engines have been known. Currently, the conventional architecture of a four-stroke poppet valve internal combustion engine is a combination of an integrated crankcase and cylinder block (formed as one unit) and a separately formed cylinder head, the cylinder head being bolted to the top of the cylinder block with a high pressure cylinder head gasket sealing the junction between the cylinder head and the cylinder block. A separately formed exhaust manifold is bolted to the cylinder head, to collect combusted gases expelled from the cylinders and to relay them to e.g. a turbocharger turbine or directly to an exhaust system (exhaust pipe and catalyst combination).

Internal combustion engines have major structural parts like cylinder head, cylinder block, crankcase and manifolds. Today's engine designs are extremely complex and the number of components have been increasing over the past couple of decades leading to increased manufacturing time, assembly time and development & production costs. The current engines also incorporate some critical joints which play a vital role in avoiding leakage of combustion gas, and some critical fluids such as cooling water and coolant. The faces on which these joints are interfaced require extremely accurate and precise machining, leading to further cost increase. Any drop in quality control in these crucial operations also leads to below-par quality/performance and part rejection. There are also other problems such as stress concentrations in undesirable areas, which are discussed, for example, in U.S. Pat. No. 6,382,167.

To elaborate further, the usual water-cooled four-stroke internal combustion engine uses circulation of working fluids combustible air/fuel mixture, coolant water and oil for lubrication. As a number of fluids are involved, there is a number possible ways in which fluid leakage can occur in conventional engine design. These are: combustion gas leakages from combustion chamber, coolant water leakages from water gallery between block and head, and lubrication oil leakages from oil gallery between block to head.

The compression in the cylinder potentially causes a leak to form in the gasket. Unless the gasket is severe damage can take place. If the faulty gasket is not replaced and if it fails, a variety of problems can occur, ranging from compression loss (leading to power reduction, or a rough engine), to exhaust gases being forced into the cooling system, leading to the engine overheating and increased engine wear due to the oil being mixed with antifreeze.

Coolant can leak into the cylinders, causing the exhaust to issue steam. If a very large amount of coolant leaks, the so-called hydro locks can occur, causing extensive engine damage.

Special efforts are also required during the conventional assembly of the head and manifold assembly. Additional storage place is also required to store the heads, manifolds, long studs and gaskets at warehouses. It thus adds up the assembly time and consequently the manufacturing cost. With mono block engines of the present invention, the huge manufacturing cost and time incurred during the conventional assembly process is completely eliminated.

Assembling of head and block is one of the crucial activities of the conventional overall engine assembly process, as the heavy weight head has to be picked from offline and assembled together with the block with gaskets, long studs and bolts. It requires special handling machines and equipment, additional man power and time to complete the activity.

The casting process itself deserves a close look as it is quite complicated for the present monoblock engines. The factors that need to be considered are the number of cores, the draw distance, and the general orientation and configuration of the external surfaces. The conventional monoblock engines include a great many of each of the complicated features such as undercuts, protrusions and simply a number of parts. The draw distance itself affects the manufacturing cycle time and the uniformity of compaction in the case of sand moulds. Therefore the draw distance should be kept to a minimum in order to ensure better disengagement. In conventional design of the casting process, the draw distance is significantly high and leads to improper disengagement of the cast engine parts. It is often found that the cast parts need repairing after casting. The orientation of the surfaces which are parallel to the draw direction is also of critical importance.

The configuration of the engine block is also of crucial importance. For example, an undercut is a feature which hinders the movement of the part while getting drawn out of the mould. Presence of undercuts also increases the number of elements in the mould, and also the cost of a core for producing a particular feature involving an undercut is significantly higher than an ordinary mould of equal volume. Undercuts (part indicated as ‘B’ in FIG. 1) lead to higher costs in terms of special materials, additional tooling and lower productivity.

Parting surface is the surface of contact between any two segments of the mould. A non planar parting design increases the complexity of the tooling so the irregular geometries like jagged edge blends, sharp chamfers, extra material projections and over radius are avoided.

A further problem with the convention monoblock engines is to do with the honing of cylinder bores. To retain the lubricant on its surface the inside of the bore needs to be cross-hatched while rendering it sufficiently smooth so that the passage of piston over is effortless. In conventional mono blocks—since the mono-block engines are bigger and complex in structure due to integration of cylinder head and manifolds—it was very difficult to hone them using traditional honing processes.

A further drawback of the conventional monoblock engines is that fixing the monoblock assembly to the crankcase is not easy. As disclosed in the GB2425570, a system of long studs and supporting pillars is used to achieve this (see FIG. 1A). Long studs are liable to breakage under critical loads. The presence of pillars not only adds to the material and construction costs but it also makes the water jacket design more complex.

The conventional monoblock engines are found to be cumbersome to cast and manufacture, have ill-efficient water jackets.

There is therefore a need to provide integrally cast monoblock engines that are easy to cast and efficient in water coolant circulation.

### OBJECTS AND ADVANTAGES OF THE INVENTION

One of the objects of the present invention is to provide a monoblock engine in which the cylinder head, cylinder block, and the inlet and outlet (exhaust) manifolds are cast integrally so as to eliminate critical joints such as the joint between cylinder head and block, and at the head and the intake manifold.

A further object of the invention is to simplify the cylinder and manifold design and eliminate some of the gaskets and mechanical fasteners used for tightening. Another object of the present invention is to provide a monoblock engine such that the leakages at the interface of the monoblock and the crankcase are minimised.

A still further object of the present invention is to provide core and core removal passages in a manner that allows easy casting and extraction of the cast product. This has been achieved by reducing the number of cores, optimizing the core design, and spatial and geometrical design that allows easy removal of core after casting.

Yet another object of the invention is to remove the requirement for flat precision surfaces and controlled machining operation thereby reducing costs and machining time.

A further object of the invention is to enable assemblage of the liner with block by push-fit method. This has the added advantage that the liner is retained by counter bore in the Crank case as shown in figure. Further, when adding the gasket between the crankcase counter bore and liner, the joint provides the essential leak-proofness from combustion gas and coolant.

A further advantage of the present invention lies in the improved cooling efficiency. This is achieved with longer or optimal path for the cooling water, and by placing the water inlet at the bottom and by letting the water out through a water outlet at the top end of the monoblock, such that hot water will get out promptly and cool water will remain in block to cool engine continuously.

### BRIEF DESCRIPTION OF THE FIGURES

FIGS. 1 and 1A show cross-sectional views of some of the existing mono block engines

FIGS. 2 and 3 show views of the monoblock engine of the invention

FIGS. 4 and 5 show perspective views of the monoblock engine of the invention

FIGS. 6 and 7 show cross sectional views of the monoblock engine of the invention

FIG. 8 shows the monoblock engine of the invention along with the crankcase

FIG. 9 shows the liner arrangement of the invention

FIG. 10 shows the gateways connecting the coolant jackets of the head and the block

FIGS. 11 and 12 show the arrangement of the invention for multiple cylinder engines

### SUMMARY OF THE INVENTION

The present invention discloses a monoblock engine in which the head and the block of the engine are cast integrally. The engine incorporates a cylinder and water coolant jackets, intake manifold and an exhaust manifold, vertical intake and exhaust valves, core removal holes, and a push-fit type cylinder liner which is secured in place so that leakage of fuel from the cylinder is eliminated. The water coolant jackets for the head and the block are connected using four water jacket gateways or connectors. The monoblock is fitted with the crankcase using a leak proof & robust flange-joint and mechanical fastening system which is easy to install. The invention is embodied for a single cylinder engine as well as multi-cylinder engines. By integrating cylinder head and manifolds with block, the critical joint between head and block and head and intake Manifold will be eliminated. At the same time, gasket and mechanical fasteners for tightening also can be eliminated. The water jacket design is communized & optimized for both head and block for better performance.

List of parts:

| | |
|---|---|
| 1. | Monoblock engine or |
| | monoblock |
| 1A. | Cylinder |
| 2. | Cylinder head |
| 3. | Cylinder block |
| 4. | Exhaust manifold |
| 5. | Intake manifold |
| 6. | Water inlet or intake |
| 7. | Water outlet |
| 8. | First flange (to mount the |
| | monoblock on to the |
| | crankcase) |
| 9. | Crank case |
| 10. | Connecting rod |
| 11. | Crankshaft |
| 12. | Piston |
| 13. | Vertical intake valve guide |
| 14. | Vertical exhaust valve guide |
| 15. | Injection bore |
| 16. | L-shaped liner base or second |
| | flange |
| 16A. | Miscellaneous flange |
| 17. | Water jacket |
| 17A. | Cylinder inside wall |
| 18. | Core removal hole |
| 19. | Partition line |
| 20. | Liner |
| 21. | Crankcase base (L-shaped) |
| | for liner |
| 22. | Gap |
| 22A. | First gasket |
| 22B. | Second gasket |
| 23. | Water jacket connector |
| 24. | Intake port |
| 25. | Common core |
| 26. | First cylinder for multiple |
| | cylinder monoblock |
| 27. | Last cylinder for multiple |
| | cylinder monoblock |
| 28. | Parallel face |

### DESCRIPTION OF THE INVENTION

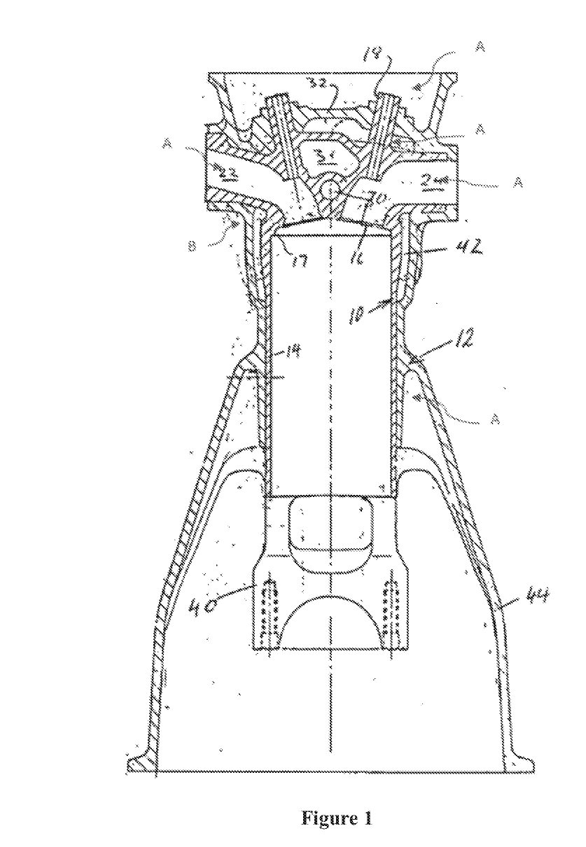

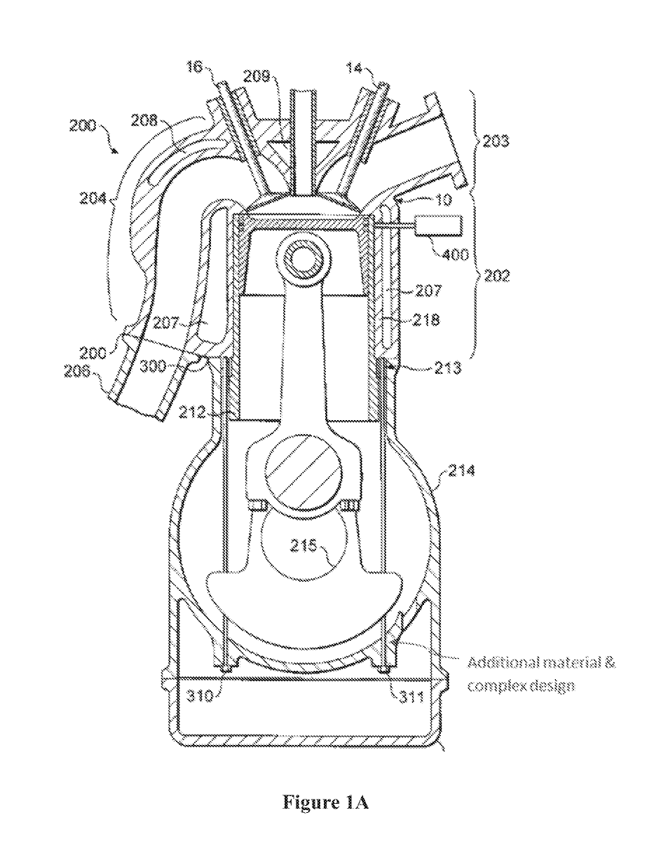

As shown in FIGS. 1 and 1A and FIGS. 2 and 3, the external and internal construction of the monoblock engine (1) are such that there are no parts that protrude awkwardly which when cast would come in the way of extracting from the casting mould.

Accordingly, the cylinder head (2) and manifold (at least one) are integrated with cylinder block (3) and shaped as a monoblock. By integrating cylinder head (2) and manifolds with block (3), the critical joint between head (2) and the block (3), and head (2) and the intake manifold (5) will be eliminated. At the same time, gaskets and mechanical fasteners for tightening also can be eliminated. The water jacket (17) design is communized and optimized for both head (2) and the block (3) for better performance. Furthermore, all openings are maintained on a partition line (19) so that core design will be easier. Special core removal holes (18) are provided in order that the water jacket (17) may be constructed as a single continuum around the block (3) as well as the head (2). Other than opening all the pockets, flanges also optimized with respect to partition line (19).

In another embodiment of the invention, the engine monoblock (1) is cooled using air rather than water. The monoblock (1) would then be provided with fins rather than a water jacket. In the air cooled design only the the cylinder inner wall (17A) will be provided which in turn would be provided with fins. All parts associated with the water jacket design in the case of the water cooled engine would be absent in this design (including the water gateways). Also in the air cooled design, there would be no need for the core removal holes associated with the water jacket.

The key aspects of the design of the monoblock engine of the present invention are evident from the attached figures.

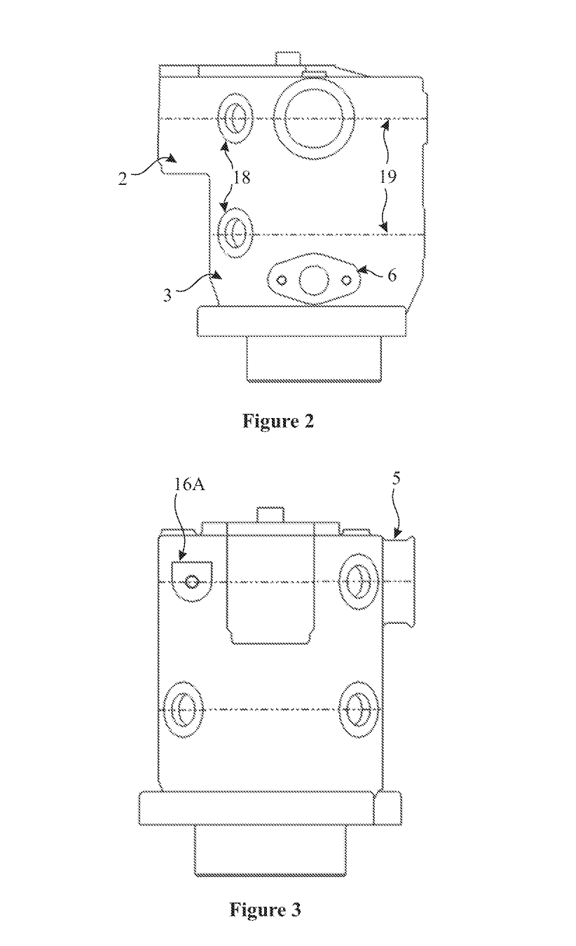

FIGS. 2 and 3 show side views of the monoblock (1) of the present invention. It shows partition lines (19) along which moulds are formed. It also shows clearly a water inlet (6) at the bottom of the block (3). It further shows a number of core removal holes (18) through which it is possible to remove cores formed during the casting process. These also show a first flange (8) at the bottom of the block (3) which is used to rigidly connect (preferably with nuts and bolts) the block (3) with the crankcase (9).

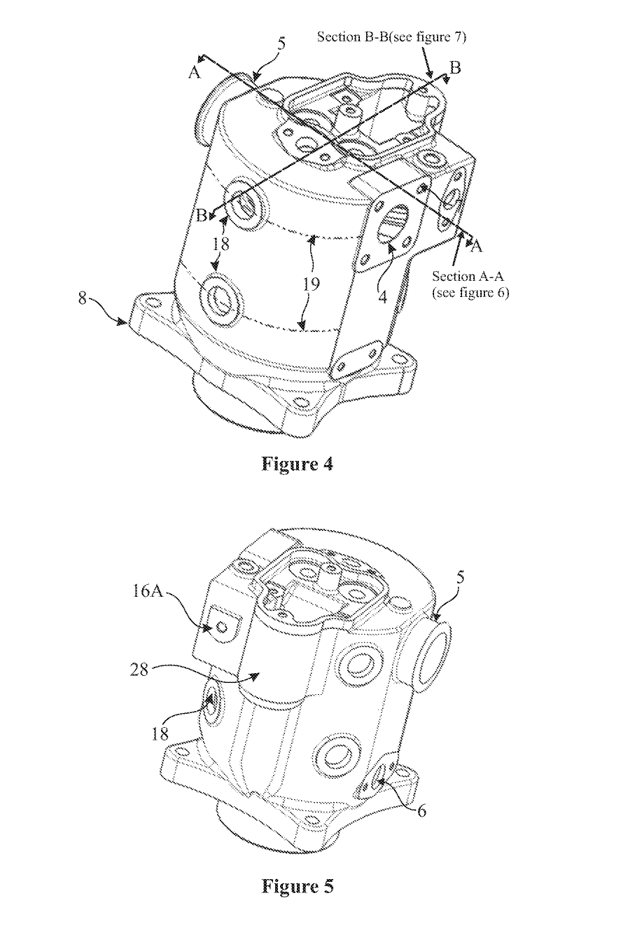

FIG. 4 shows a perspective view of the monoblock (1) of the present invention. It shows clearly the compactness of the monoblock (1) and which is devoid of awkwardly protruding parts. It can also be seen that the monoblock (1) does not need a number of loose cores (similar to those indicated by letter ‘A’ in FIG. 1) during the process of casting. It also shows a water outlet (7) situated near the top.

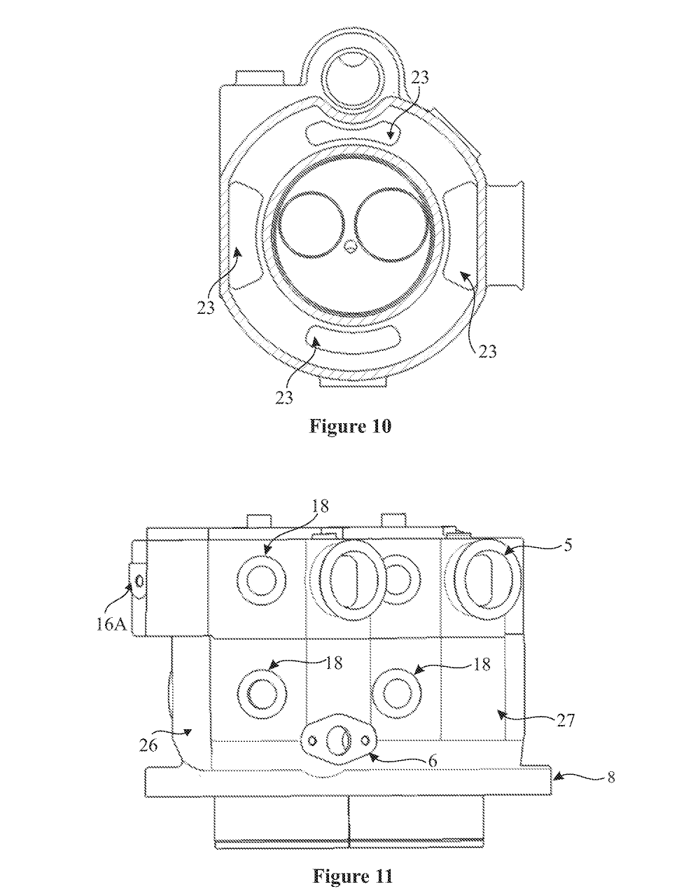

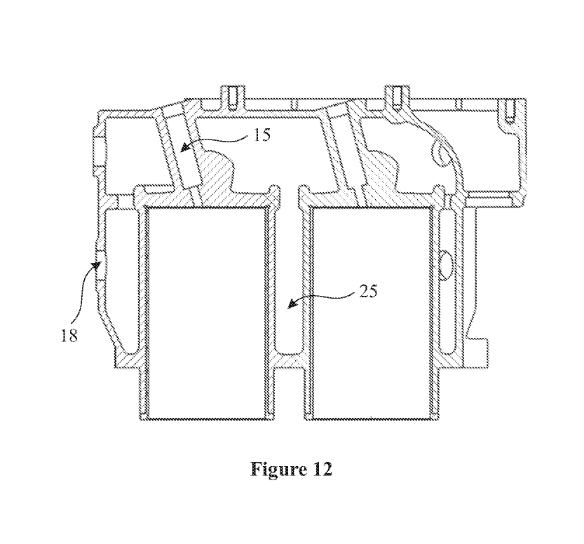

FIG. 5 shows a cross sectional view taken through the monoblock (1). It can be clearly seen that the water jacket (17) forms a single continuum around the head (2) as well as the block (3) part of the monoblock (1). The volume afforded by the water jacket (17) is much greater than that provided by the conventional monoblocks and it has been done in a way that avoids congestion (as compared to the monoblocks of the prior art—see FIGS. 1 and 1A). The water jacket gateways (23) or connectors (see FIG. 10) that connect the water jacket (17) portions of the head (2) and the block (3) are clearly seen from FIG. 5. This is a novel feature of the present monoblock (1).

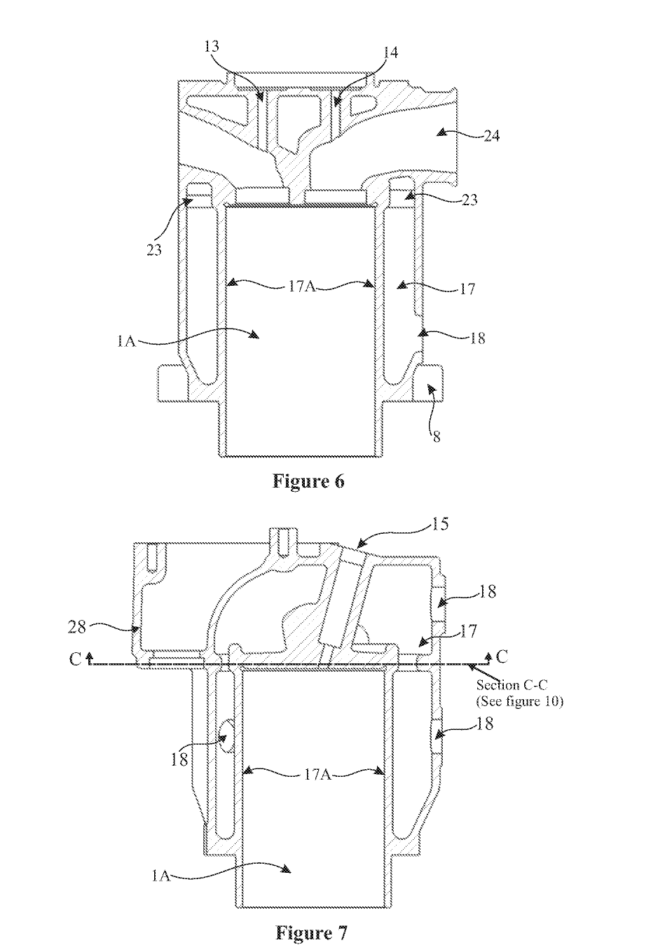

FIG. 6 shows another novel feature of the present monoblock engine (1)—the intake and exhaust valve guides (13, 14) which are oriented with their axes parallel to the axis of the cylinder (1A). For a vertically mounted engine these valves become oriented vertically. The intake and exhaust valves in the conventional monoblocks are not parallel to the cylinder axis (or non-vertical in the case of vertically oriented cylinder) as can be seen from FIGS. 1 and 1A.

A further novel feature of the present invention is the cylinder liner (20) that is manufactures separately and push-fitted in the cylinder (1A). Since the separately manufactured sleeve is much easier to handle, it simplifies the honing process with the result that the finish of the surface on which the piston moves meets the most stringent accuracy requirements for such surfaces.

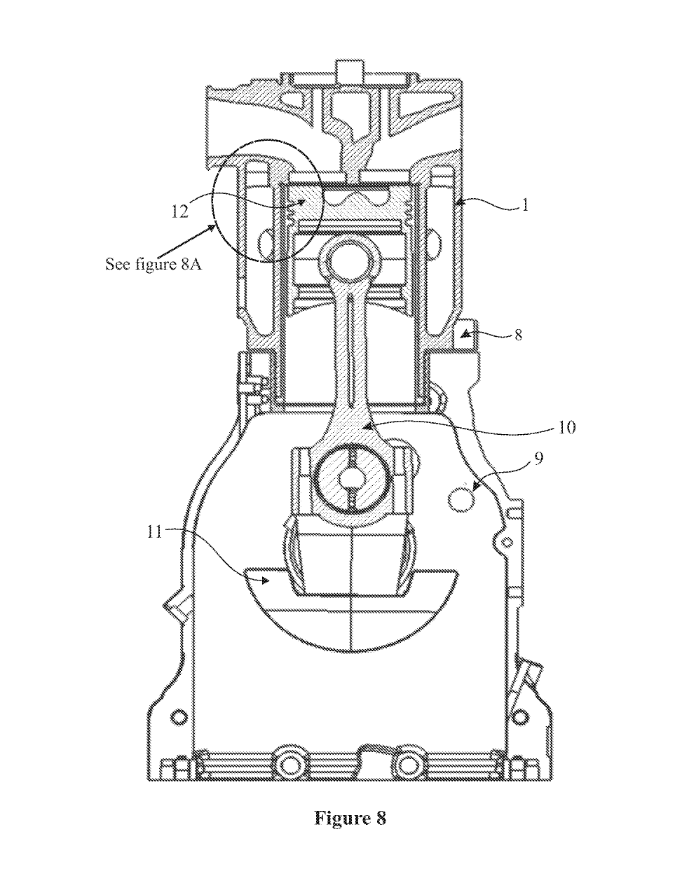

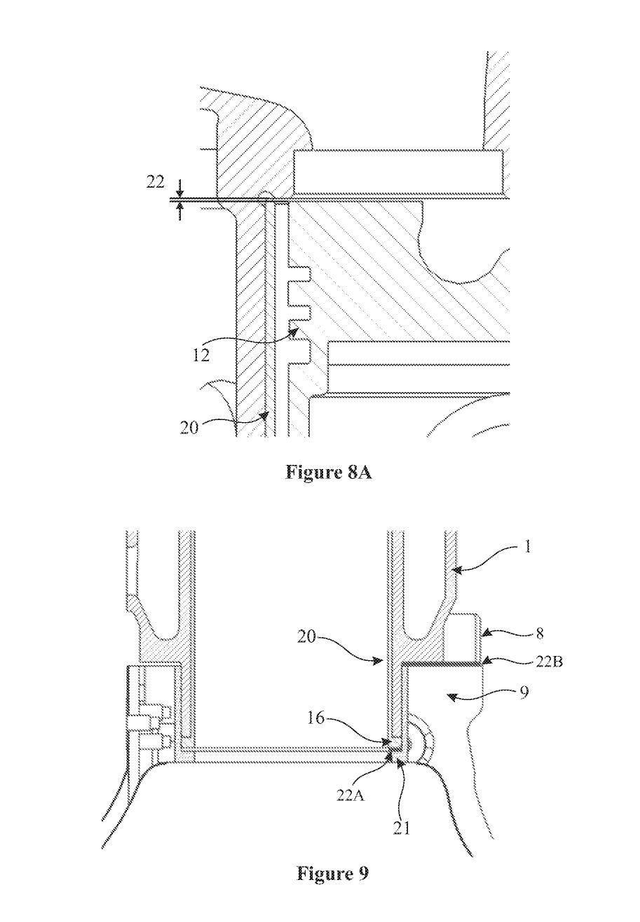

Further, as shown in the FIG. 9, the cylinder liner (20) is provided with a special L-shaped second flange (16) which sits on an L-shaped base/seat (21) provided at the top of the crankcase (9). These two L-shaped features ensure that the liner (20), once push-fitted inside the cylinder, is securely positioned in place and fixed to the crankcase (9). A first gasket (22A) is provided between the two L-shaped features. The joint thus formed is found to be completely secure, leak proof and reliable in containing the combustion gases and fluids.

The constructional features of the present invention are now described in greater detail in order to understand the advantages that it offers over the conventional monoblock engines.

The monoblock engine (1) of the present invention is designed to reduce the number of joints, in particular the critical joints and also rid the engine of the gaskets between the head (2) and the block (3), and between the head (2) and the intake manifold (5). This makes monoblock engine (1) of the present invention more ‘healthy’ than a conventional engine.

Further, in case of the monoblock engine (1) of the present invention (as compared with a conventionally designed engine containing two major critical joints), eight long studs and bolts and two gaskets are avoided. Avoidance of the critical joints also means avoidance of the requirement of the accurate machining on mating surfaces and margin casting materials for machining. The monoblock engine (1) of the present invention this helps to reduce machining and material cost.

Parting lines divide the part surface into separate regions each produced by a different mould segment. The monoblock engine (1) of the present invention contains two partition lines (19). This reduces the draw distance and makes the process of separating the cast part from the mould easier than the conventional monoblocks.

As is evident from consideration of FIGS. 4 and 5, the irregular pockets and protrusions are avoided in the present invention. The centres of core removal holes (18), which all are provided on partition lines (19), are positioned at locations that make it convenient for cores to be removed easily. The miscellaneous flanges (16A) to connect any parts to the monoblock (1) have been optimized in their configuration to have uniformity shape at below and above the line. The water jackets (17) which are designed to circulate water around the monoblock (1) are cast as a simple uniform structure. The end result is that undercuts such as those seen in FIGS. 1 and 1A are completely avoided in the present invention and dragging of cast parts from the moulds made simple.

As a further feature of the construction of the monoblock engine (1) of the present irregular geometries like jagged edge blends, sharp chamfers, extra material projections and over radius are avoided. A drawback of the conventionally cast engines is that they contain such parting surfaces which increases the complexity of the tooling. This increases the security and leak-proofness of the joint against the combustion gases and fluids.

In one embodiment of the present invention, the monoblock (1) is water cooled with the help of a water jacket (17) which is provided to circulate water around the cylinder (1A) in order to maintain the cylinder temperature at an acceptable level. In the casting process, required water jacket (17) shapes are generated by providing inserts called cores. Cores are made by baking sand with some binder so that they can retain their shape when handled. The mould is assembled by placing the core into the cavity of the drag, and then placing the cope on top, and locking the mold. After the casting is done, the sand is shaken off, and the core is pulled away and usually broken off. The removing the core from mold is one of the critical process after casting, As seen from FIGS. 4 and 5, in the case of the monoblock (1) of the invention the core removal process is made easier by keeping many core removal openings (18) around the monoblock (1).

With regards the design of valves in conventional design, valve design is typically angled (see FIGS. 1 and 1A). This creates difficulty during machining as special tools and set up required to do the special machining. This also increases machining cost and timing besides the fact that it also requires skilled operator and focused monitoring during the machining process. In the monoblock engine (1) of the present invention, as shown in FIG. 6, valves (13, 14) with their axes parallel to the axis of the cylinder have been introduced. This allows easy access for machining either from bottom side or top side. It thus reduces the overall machining cost and time and makes serviceability easier.

Honing of the cylinder bore of conventional engines is a difficult process as the entire cylinder, which is heavy and bulky, needs to be handled. The present invention overcomes this drawback as it uses a separate dry liner (20) which is push fitted on monoblock (1) by pushing it inside the cylinder (1A). The dry liner (21) is much lighter in weight than the cylinder itself and therefore much easier and simpler to handle during honing. It can also be easily assembled and disassembled.

The fixing of the monoblock (1) assembly of the present invention to the crankcase (9) is considerably easier in the present invention. It is achieved by mounting the monoblock (1) onto the crankcase (9) with the use of a four-hole first flange (8). A second gasket (22B) is provided between the first flange (8) and top of the crankcase. The joint between the monoblock and the crankcase is thus very sturdy and leak proof. There are savings in material as compared with the conventional monoblocks due to this feature alone and the design of water jackets (17) is simplified greatly.

A further inventive feature of the present monoblock engine (1) is its variable compression ratio. Dead volume of the present monoblock (1) can be varied by changing the thickness of two gaskets (22A and 22B) as shown in FIG. 9. By varying the thickness of these two gaskets, the distance or the gap (22) between piston top face and the monoblock (1) is controlled, which directly influences the dead volume and consequently the compression ratio.

Of the various aspects that influence the engine performance, the swirl ratio and the ability of the coolant to flow freely are important. The swirl ratio is defined as the ratio between air rotational speed at the intake port (24) and crankshaft rotational speed. The present invention achieves a swirl ratio of 2.5 for single- or multi-cylinder monoblock engines.

The other feature of the present invention is that the monoblock (1) may be constructed with ease for single cylinder or multiple cylinders simply by inserting a common core (25) between any two adjacent cylinders thereby allowing a single common water jacket (17) for all cylinders of the monoblock (1). In the case of multiple cylinder monoblocks in which cylinders are arranged in a linear arrangement, the water intake (6) is preferably situated at the bottom of the first cylinder (26) and the outlet (7) at the top of the last cylinder.

It can thus be seen that the invention thus has the following embodiments.

According to the first embodiment, the monoblock engine (1) of the present invention comprises an integrated cylinder head (2) and a cylinder block (3) characterized in that said monoblock engine is securely connected to said crankcase provided with a first flange provided at the bottom of said cylinder block to securely connect it to the crankcase.

In the next embodiment, the monoblock engine is provided with a cooling system based on a fluid such as water.by providing a water jacket (17) for both said cylinder head (2) and said cylinder block (3), such that the water jacket is a single continuum connected through water gateways (23) placed at the junction of said cylinder block (3) and said cylinder head (2).

In another embodiment, the cooling fluid is air which is circulated around the monoblock using a system of fins. In this embodiment, the water jacket and all the associated constructional features are not present.

In a further embodiment, the monoblock engine (1) further comprises an externally manufactured sleeve which is push-fitted in the cylinder bore.

In a still further embodiment, the intake valve and the exhaust valves (13, 14) are oriented parallely to the cylinder axis, which is vertical in the case of a vertically oriented monoblock.

In another embodiment, the sleeve is provided with an L-shaped second flange (16) to be supported by an L-shaped seat provided at the top of the crankcase (9).

In still another embodiment, at least one core removal hole (18) is provided, said core removal hole (18) being plugged with a welch plug after construction of the monoblock engine (1).

In yet another embodiment, the external surface of the monoblock (1) is substantially cylindrical.

In a further embodiment, the water inlet (6) is provided near the bottom of the cylinder block (3) and the water outlet (7) is provided near the top of the cylinder block (3).

In another embodiment gaskets are provided below the first and second flanges such that the gasket thickness is variable.

In a yet further embodiment, nuts and bolts are used to connect said flange with said crankcase (9).

In another embodiment a monoblock engine is provided characterized in that the number of cylinders is greater than one and such that each of said cylinders has an integrally cast cylinder head and a cylinder block. A common core (25) is inserted between any two cylinders.

In still another embodiment a monoblock engine is provided characterized in that the water inlet is provided near the bottom of the cylinder block of the first cylinder and the water outlet is provided near the top of the last cylinder block.

In a still further embodiment, a monoblock engine is provided characterized in that the said monoblock engine is fired using compression ignition or spark ignition.

In yet another embodiment, a process of manufacturing a monoblock engines disclosed in any one of the earlier embodiments is provided, characterized in that said process comprises the step of providing at least two partition lines during the process of casting.

In another embodiment, a process of manufacturing a monoblock engines as claimed in the immediately previous embodiment is disclosed, wherein in the case of a water cooled engine said process further comprises the step of providing at least one core removal hole.

The invention provides several advantages as listed earlier. There are further advantages due to ease of serviceability and enhanced durability. These are as below:
The valve seats are placed with valves so that after service time if needed, only valve seat will get replaced with new one, protecting the casting block/monoblock and valves will remain same.
The monoblock will be assembled with crankcase by flange design with simple bolts. Assembly and disassembly of mono block during engine assembly or service will be much easier.
The liner is easily removable and replaceable. During service time it can be easily removed and honing pattern can be done. It again gets assembled by push-fit method leading to ease of serviceability of the liner.
The long studs that are used in fastening the existing monoblocks with crankcases are eliminated. The existing methods uses long studs from top to bottom. In the present invention, a simple flange is added at bottom of monoblock and respectively bosses added in crankcase so by simple fastening/bolting monoblock can be fitted to the crankcase. This also provides a stronger joint and enhanced durability.
The wall and duct thicknesses are optimized to withstand combustion loads and mechanical loads so the design will be more reliable and also cost effective with casting weight-optimization.
Innovative design for positioning/location of spaces/through-holes in the casting for components such as injector, valves etc, enables easier and cost effective machining, like with enabling access for machining such portions from bottom open side of the block.
Other benefits like the assembly time for assembling head, manifolds with cylinder block in assembly line will be saved. The same design can be used for gasoline application also with the machining changes.

While the above description contains much specificity, these should not be construed as limitation in the scope of the invention, but rather as an exemplification of the preferred embodiments thereof. It must be realized that modifications and variations are possible based on the disclosure given above without departing from the spirit and scope of the invention. Accordingly, the scope of the invention should be determined not by the embodiments illustrated, but by the appended claims and their legal equivalents.

1. A monoblock engine for automotive vehicles having at least one cylinder, said cylinder having an integrated cylinder head and a cylinder block characterized in that said monoblock engine is securely connected to said crankcase provided with a first flange provided at the bottom of said cylinder block to securely connect it to the crankcase.

2. A monoblock engine as claimed in claim 1 characterised in that the cooling fluid for said cylinder block is water which is circulated around the monoblock through a water jacket which is formed as a single continuum connected through water gateways placed at the junction of said cylinder block and said cylinder head.

3. A monoblock engine as claimed in claim 1 characterised in that the cooling fluid for said cylinder block is air which is circulated around said monoblock with the help of a system of fins.

4. A monoblock engine as claimed in claim characterised in that it further comprises an externally manufactured liner which is push-fitted in the cylinder bore.

5. A monoblock engine as claimed in claim 4, characterized in that the intake valve and the exhaust valves of said engine are aligned parallely to the cylinder axis.

6. A monoblock engine as claimed in claim 5, characterized in that, the liner is provided with a L-shaped second flange to be supported by an L-shaped seat provided at the top of the crankcase.

7. A monoblock engine as claimed in claim 6, characterized in that at least one core removal hole is provided, said core removal hole being plugged with a welch plug after removal of said monoblock engine from the casting mould.

8. A monoblock engine as claimed in claim 7, characterized in that the external surface of the monoblock is substantially cylindrical.

9. A monoblock engine as claimed in claim 8, characterized in that in the case of the monoblock having a single cylinder, the water inlet is provided at the bottom of the cylinder block and the water outlet is provided near the top of the cylinder block.

10. A monoblock engine as claimed in claim 9, wherein the gaskets provided underneath the first flange and the second flange are of variable thickness.

11. A monoblock engine as claimed in claim 10, characterized in that nuts and bolts are used to connect said flange with said crankcase.

12. A monoblock engine as claimed in claim 11, characterized in that the number of cylinders is greater than one and that each of said cylinders has an integrally cast cylinder head and a cylinder block.

13. A monoblock engine as claimed in claim 12, characterized in that a common core is provided between any two adjacent cylinders.

14. A monoblock engine as claimed in claim 13, characterized in that the water inlet is provided near the bottom of the cylinder block of the first cylinder and the water outlet is provided near the top of the last cylinder block.

15. A monoblock engine as claimed in claim 14, characterized in that the said monoblock engine is fired using compression ignition or spark ignition.

16. A process of manufacturing a monoblock engines disclosed in any one of the claim 15 characterized in that said process comprises the step of providing at least two partition lines during the process of casting.

17. A process of manufacturing a monoblock engines as claimed in claim 16, wherein in the case of a water cooled engine said process further comprises the step of providing at least one core removal hole.
